(19) United States
(12) Patent Application Publication
(10) Pub. No.: US 2004/0252827 A1
(43) Pub. Date: Dec. 16, 2004

(54) Echo canceler, echo canceling method, and recording medium

(75) Inventor: Hideaki Sasaki, Onojo-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/866,746

(22) Filed: Jun. 15, 2004

(30) Foreign Application Priority Data
Jun. 16, 2003 (JP) 2003-170300
May 13, 2004 (JP) 2004-143469

(51) Int. Cl. H04M 9/08

(52) U.S. Cl. 379/406.08; 379/406.01

(57) ABSTRACT

The invention aims to provide an echo canceler capable of detecting the misadaptation at an early stage and correcting it, thereby preventing echo and howling even when receiving a periodical signal and a fan noise.

It is an echo canceler 108 of a phone terminal having a line connector for connecting to a network, a speaker for supplying voice received from a far-end speaker, and a microphone for receiving voice of a close-end speaker, which comprises a filter 204 for eliminating the echo component reflected back from the speaker to the microphone, a transfer function estimating unit 202 for estimating a transfer function of the echo component, a coefficient judging unit 205 for judging a coefficient value of the filter 204, and a coefficient updating unit 203 for updating the coefficient value of the filter 204, based on the estimation result in the transfer function estimating unit 202 and the judgment result in the coefficient judging unit 205.

### BACKGROUND OF THE INVENTION

1. Field of the Invention

The present invention relates to an echo canceler for use in a phone terminal used through connection to a network such as a phone line, an echo canceling method in the phone terminal, and a recording medium for performing the echo canceling method.

2. Description of the Related Art

As a device for suppressing echo occurring in a phone line (hereinafter, referred to as a line simply), there is an echo canceler. According to the echo canceler, it is possible to eliminate echo by subtracting a signal overlaid with a transfer function of pseudo-simulating a path and an outgoing signal to an echo path, from an echo signal supplied to the device passing through the echo path. Hereinafter, the conventional echo canceler will be described by using Patent Article 1.

FIG. 11 is a block diagram showing the conventional echo canceler described in the JP-A-08-079136.

In FIG. 11, the reference numeral 1101 indicates an echo canceler, the reference numeral 1102 indicates an adaptive filer for performing a convolution operation on a reception signal from a line 1, the reference numeral 1103 indicates a subtracter, the reference numeral 1104 indicates a squared error calculator for calculating a squared error signal as for the signal obtained after subtraction by the subtracter 1103, the reference numeral 1105 indicates a judging unit for comparing the squared error signal with a threshold, the reference numeral 1106 indicates a tap coefficient memory for recording a tap coefficient, and the reference numeral 1107 indicates a tap coefficient comparator for estimating a proper tap coefficient.

The operation of thus constituted echo canceler 1101 will be described.

Upon receipt of a reception signal from the line 1, the reception signal is branched into two within the echo canceler 1101: one is supplied to a line 2 and the other is supplied to the adaptive filer 1102. In the adaptive filer 1102, a tap coefficient is read out from the tap coefficient memory 1106, and after the convolution operation with the reception signal, a pseudo echo signal is generated. The generated pseudo echo signal is supplied to the subtracter 1103 and subtracted from the echo signal. A signal obtained after the subtraction is simultaneously given to the squared error calculator 1104, where a squared error signal as for the signal obtained after subtraction is calculated and the result is supplied to the adaptive filter 1102 and the judging unit 1105. The judging unit 1105 has a threshold, compares the squared error signal with this threshold, judges a difference between the squared error signal and the threshold, and supplies a control signal indicating this result to the tap coefficient comparator 1107. According to the result indicated by the control signal, the tap coefficient comparator estimates a proper tap coefficient.

The above conventional echo canceler, however, has such a disadvantage that when receiving a periodic signal such as a sine wave or a dial tone, or when receiving a noise from a fan of an air conditioner (fan noise), the adaptive filer 1102 misunderstands the signal, which results in an increase of echo and howling.

The echo canceler, echo canceling method, and recording medium are required to detect the misadaptation at an early stage and correct it in order to prevent from echo and howling, even when receiving a periodic signal such as a sine wave or a dial tone or when receiving a fan noise.

### SUMMARY OF THE INVENTION

In order to satisfy this request, the invention is to provide an echo canceler and an echo canceling method capable of detecting the misadaptation at an early stage and correcting it so as to prevent from echo and howling even when receiving a periodic signal and a fan noise, and a recording medium for performing the above echo canceling method.

In order to achieve the above object, an echo canceler of the invention is an echo canceler of a phone terminal having a line connector for connecting to a network, a speaker for supplying voice received from a far-end speaker, and a microphone for receiving voice of a close-end speaker, which canceler comprises a filter for eliminating at least one of line echo component reflected back in the line connector and acoustic echo component reflected back from the speaker to the microphone, a transfer function estimating unit for estimating a transfer function of the echo component, a coefficient judging unit for judging the coefficient values of the filter, and a coefficient updating unit for updating the coefficient values of the filter, based on the estimation result in the transfer function estimating unit and the judgment result in the coefficient judging unit.

In order to solve the above problem, an echo canceling method of the invention is an echo canceling method in a phone terminal having a line connector for connecting to a network, a speaker for supplying voice received from a far-end speaker, and a microphone for receiving voice of a close-end speaker, which canceler comprises a filter step for eliminating at least one of line echo component reflected back in the line connector and acoustic echo component reflected back from the speaker to the microphone, a transfer function estimating step for estimating a transfer function of the echo component, a coefficient judging step for judging a coefficient value of the filter in the filter step, and a coefficient updating step for updating the coefficient value of the filter in the filter step, based on the estimation result in the transfer function estimating step and the judgment result in the coefficient judging step.

In order to solve the above problem, a recording medium of the invention is a computer readable recording medium, in which a program for performing each step of the echo canceling method is recorded.

According to the echo canceler, the echo canceling method, and a recording medium of the invention, since the coefficient values of the filter are updated based on the estimation result in the transfer function estimating unit and the judgment result in the coefficient judging unit, even when receiving a periodical signal and a fan noise, it is possible to detect misadaptation at an early stage and correct it, thereby preventing echo and howling.

### BRIEF DESCRIPTION OF THE DRAWINGS

FIG. 1 is a block diagram showing a general phone terminal.

FIG. 2 is a function block diagram showing the central processing unit as the echo canceler of the phone terminal of FIG. 1.

FIG. 3(a) is a graph showing an example of learning a transfer function normally (state without periodical signal) and (b) is a graph showing an example of misadaptation it under the presence of periodical signal (the other conditions are the same).

FIG. 4 is a flow chart showing the echo canceler of FIG. 2.

FIG. 5 is a flow chart showing the coefficient judging step of FIG. 4.

FIG. 6(a) is a graph showing an example of learning a transfer function normally (state without fan noise) and (b) is a graph showing an example of misadaptation it under the presence of fan noise (the other conditions are the same).

FIG. 7 is a flow chart showing the coefficient judging step of FIG. 4.

FIG. 8 is a flow chart showing the coefficient updating step of FIG. 4.

FIG. 9 is a function block diagram showing the echo canceler according to the third embodiment of the invention.

FIG. 10 is a flow chart showing the coefficient judging step of FIG. 4.

FIG. 11 is a block diagram showing the conventional echo canceler.

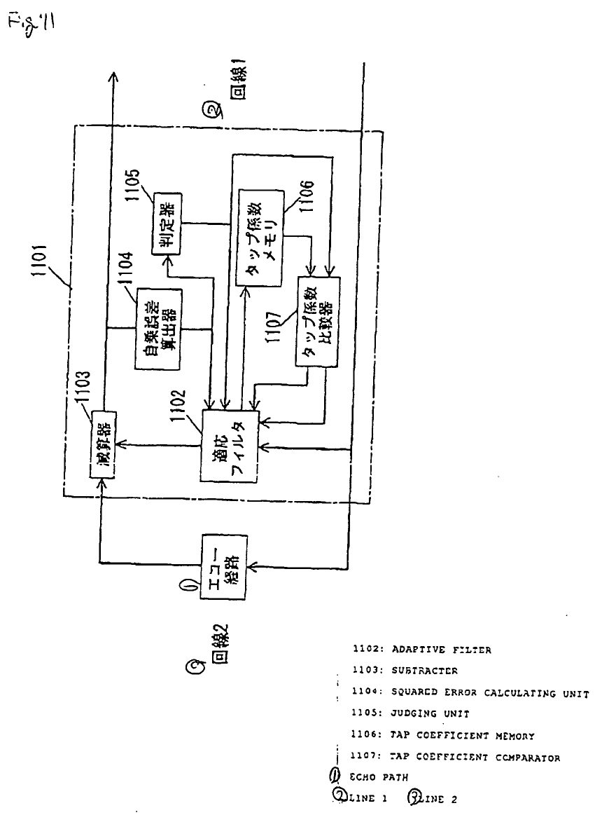

### DESCRIPTION OF THE PREFERRED EMBODIMENTS

A first echo canceler of the invention is an echo canceler of a phone terminal having a line connector for connecting to a network, a speaker for supplying voice received from a far-end speaker, and a microphone for receiving voice of a close-end speaker, which canceler comprises a filter for eliminating at least one of line echo component reflected back in the line connector and acoustic echo component reflected back from the speaker to the microphone, a transfer function estimating unit for estimating a transfer function of the echo component, a coefficient judging unit for judging coefficient values of the filter, and a coefficient updating unit for updating the coefficient values of the filter, based on the estimation result in the transfer function estimating unit and the judgment result in the coefficient judging unit.

According to this structure, since the coefficient values of the filter are updated based on the estimation result in the transfer function estimating unit and the judgment result in the coefficient judging unit, even when receiving a periodical signal and a fan noise, it is possible to detect misadaptation at an early stage and correct it, thereby preventing echo and howling.

A second echo canceler of the invention, in addition to the first echo canceler of the invention, is designed in that the coefficient judging unit judges the presence of periodicity of zero cross points of coefficients.

According to this structure, since it is possible to make the judgment result in the coefficient judging unit accurate, even when receiving a periodical signal and a fan noise, it is possible to detect misadaptation at an early stage and correct it, thereby preventing echo and howling more stably.

A third echo canceler of the invention, in addition to the first echo canceler of the invention, is designed in that the coefficient judging unit judges the presence of attenuation of coefficient power.

According to this structure, since it is possible to make the judgment result in the coefficient judging unit accurate, even when receiving a periodical signal and a fan noise, it is possible to detect misadaptation at an early stage and correct it, thereby preventing echo and howling more stably.

A fourth echo canceler of the invention, in addition to one of the first canceler to the third echo canceler of the invention, further comprises a warning unit for aurally or visually warning when the judgment result in the coefficient judging unit is misadaptation.

According to this structure, it is possible to notify a user of the misadaptation, which can restrain the user from using the system under a circumstance where some signal disturbing the canceling processing of echo and howling occurs, thereby performing a stabler canceling operation.

A fifth echo canceling method of the invention is an echo canceling method in a phone terminal having a line connector for connecting to a network, a speaker for supplying voice received from a far-end speaker, and a microphone for receiving voice of a close-end speaker, which method comprises a filter step for eliminating at least one of line echo component reflected back in the line connector and acoustic echo component reflected back from the speaker to the microphone, a transfer function estimating step for estimating a transfer function of the echo component, a coefficient judging step for judging coefficient values of the filter in the filter step, and a coefficient updating step for updating the coefficient values of the filter in the filter step, based on the estimation result in the transfer function estimating step and the judgment result in the coefficient judging step.

According to this structure, since the coefficient values of the filter are updated based on the estimation result in the transfer function estimating step and the judgment result in the coefficient judging step, even when receiving a periodical signal and a fan noise, it is possible to detect misadaptation at an early stage and correct it, thereby preventing echo and howling.

A sixth echo canceling method of the invention, in addition to the fifth echo canceling method of the invention, is designed in that in the coefficient judging step, the presence of periodicity of zero cross points of coefficients is judged.

According to this structure, since it is possible to make the judgment result in the coefficient judging step accurate, even when receiving a periodical signal and a fan noise, it is possible to detect misadaptation at an early stage and correct it, thereby preventing echo and howling.

A seventh echo canceling method of the invention, in addition to the fifth echo canceling method of the invention, is designed in that in the coefficient judging step, the presence of attenuation of coefficient power is judged.

According to this structure, since it is possible to make the judgment result in the coefficient judging step accurate, even when receiving a periodical signal and a fan noise, it is possible to detect misadaptation at an early stage and correct it, thereby preventing echo and howling more stably.

An eighth echo canceling method of the invention, in addition to one of the fifth to the seventh echo canceling methods of the invention, comprises a warning step for aurally or visually warning when the judgment result in the coefficient judging step is misadaptation.

According to this structure, it is possible to notify a user of misadaptation, which can restrain the user from using the system under the circumstance where some signal disturbing the canceling processing of echo and howling occurs, thereby performing a stabler canceling operation.

A ninth recording medium of the invention is a computer readable recording medium, in which a program for performing each step of the echo canceling method according to one of the fifth to the eighth methods of the invention is recorded.

According to this structure, one of the fifth to the eighth echo canceling methods of the invention can be performed at any place at any time only by reading the recording medium by a computer.

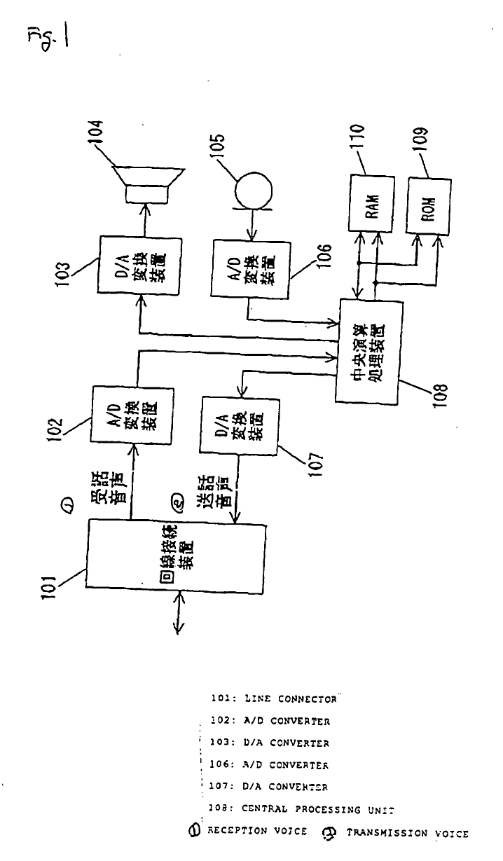

Hereinafter, preferred embodiments of the invention will be described according to FIG. 1 to FIG. 10.

(Embodiment 1)

FIG. 1 is a block diagram showing a general phone terminal, that is, a speakerphone.

In FIG. 1, the reference numeral 101 indicates a line connector having an interface with a phone line, the reference numeral 102 indicates a first A/D converter for converting a received audio signal that is an analog signal into a digital signal, the reference numeral 103 indicates a first D/A converter for converting the digital signal into an analog signal, the reference numeral 104 indicates a speaker for converting the analog signal from the D/A converter 103 into voice, the reference numeral 105 indicates a microphone for converting the voice into an analog signal, the reference numeral 106 indicates a second A/D converter for converting the analog signal from the microphone into a digital signal, the reference numeral 107 indicates a second D/A converter for converting the digital signal into an analog signal, the reference numeral 108 indicates a central processing unit (echo canceler) for performing the digital signal processing on the digital signals obtained from the A/D converter 102 and the A/D converter 106 and supplying the results to the D/A converter 103 and the D/A converter 107 respectively, the reference numeral 109 indicates a ROM (Read Only Memory) in which a program for operating the central processing unit 108 as the echo canceler is stored, and the reference numeral 110 indicates a RAM (Random Access Memory) used when the central processing unit 108 operates according to the program stored in the ROM 109.

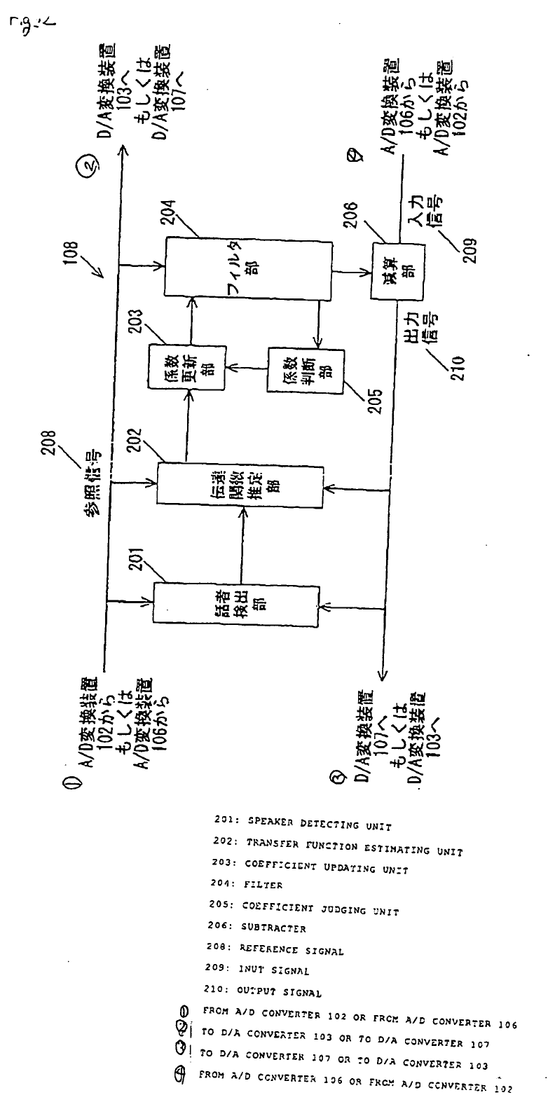

FIG. 2 is a functional block diagram showing the central processing unit 108 as the echo canceler of the phone terminal of FIG. 1, showing the functional block realized by performing the program stored in the ROM 109.

In FIG. 2, the reference numeral 201 indicates a speaker detecting unit for detecting a speech of a speaker at a far end, a speech of a speaker at a close end, and double talk (simultaneous speech of the both speakers at the far end and the close end), the reference numeral 202 indicates a transfer function estimating unit for estimating a transfer function of the space between the speaker 104 and the microphone 105 or a transfer function of the line connector 101 by using a method capable of estimating a transfer function like NLMS (Normalized Least Mean Square) method, the reference numeral 204 indicates a filter for generating a pseudo echo component through convolution operation with a reference signal 208 and the transfer function estimated in the transfer function estimating unit 202, the reference numeral 203 indicates a coefficient updating unit for updating tap coefficients within the filter 204 based on the estimation result of the transfer function estimating unit 202, the reference numeral 205 indicates a coefficient judging unit for judging the state of the tap coefficients within the filter 204, and the reference numeral 206 indicates a subtracter. The reference numeral 209 is an input signal before the subtraction of echo component and the reference numeral 210 is an output signal obtained by subtracting the pseudo echo component from the input signal 208 in the subtracter 206. In this structure, the operation of the coefficient updating unit 203 can be controlled according to the judgment result of the state of the coefficients in the filter 204. As illustrated in FIG. 2, echo cancel can be performed on the signals in the both directions (in the direction from the A/D converter 102 to the D/A converter 103 and in the direction from the A/D converter 106 to the D/A converter 107).

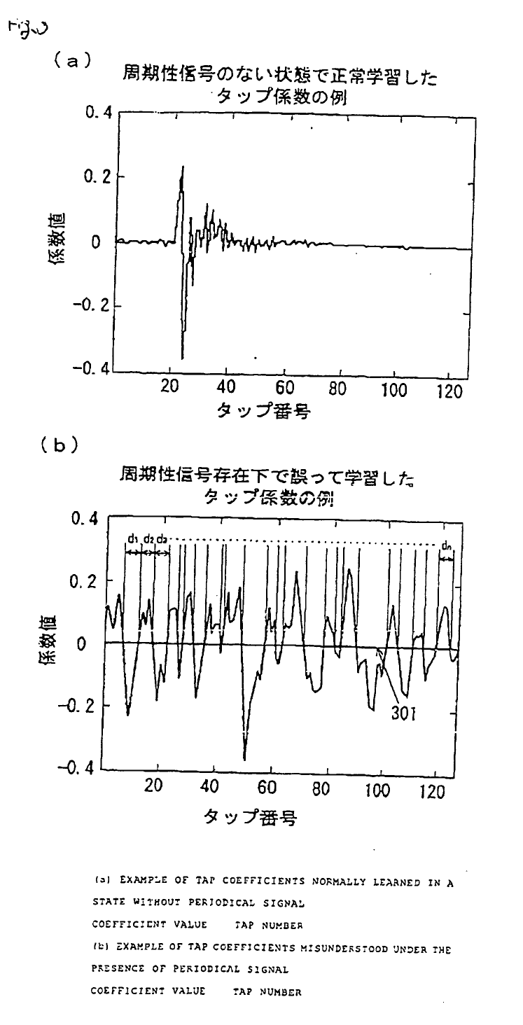

FIG. 3 shows a comparison about learning of the tap coefficients within the filter 204 depending on the presence of the periodic signal: FIG. 3(a) is a graph showing an example of learning the transfer function normally (state without periodic signal) and FIG. 3(b) is a graph showing an example of misadaptation it under the existence of periodic signal (the other conditions are the same).

A zero cross point of the tap coefficient will be described by using FIG. 3.

The zero cross point of the tap coefficient is a point of crossing a line graph of the tap coefficients with the line of the coefficient zero (the line 301 in FIG. 3(b)) when the tap coefficients are plotted as a line graph with the coefficient values represented by the vertical axis and the tap number represented by the horizontal axis.

From FIG. 3, it is found that there is a difference of the tap coefficient values of the filter 204 between at the normal learning time and at the misadaptation time under the presence of the periodic signal. Especially, at the misadaptation time, the zero cross points of the tap coefficients present periodicity. Taking notice to this quality, the coefficient judging unit 205 judges a difference of the both, thereby making it possible to check whether the tap coefficients within the filter 204 are in a preferable state or not.

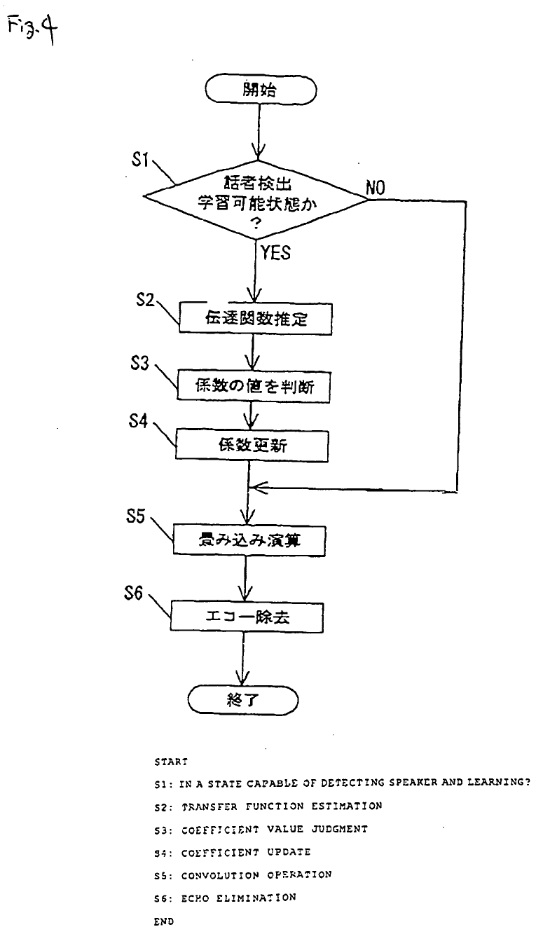

FIG. 4 is a flow chart showing the operation of the echo canceler of FIG. 2, showing the echo canceling method of the speakerphone.

In FIG. 4,.when starting the echo canceling processing, at first, the speaker detecting unit 201 judges whether it is a speech of a speaker on a far end, a speech of a speaker on a close end, and a double talk (state judging step S1); when it is in a state capable of learning, the transfer function estimating unit 202 estimates a transfer function (transfer function estimating step S2) by using the algorithm such as the NLMS method; the coefficient judging unit 205 judges the state of misadaptation according to the coefficient value of the filter 204 (coefficient judging step S3); and based on the judgment result, the coefficient updating unit 203 updates the transfer function of the filter 204 (coefficient updating step S4). Next, the filter 204 performs a convolution operation with the transfer function and the reference signal 208 (filter step S5) and generates a pseudo echo component; and the subtracter 206 generates the output signal 210 by subtracting the pseudo echo component from the input signal 209 (subtracting step S6), thereby finishing this processing.

When it is judged to be in an incapable state of learning in the state judging step S1, the operation moves to the filter step S5 without updating the coefficient values of the filter 204. Subtraction performed by the subtracter 206 may be done by the filter 204 and the filter 204 and the subtracter 206 may be collectively formed as a filter. In other words, generation of the pseudo echo component in the filter step S5 and elimination of the line echo component or the acoustic echo component in the subtracting step S6 may be performed collectively in the filter step.

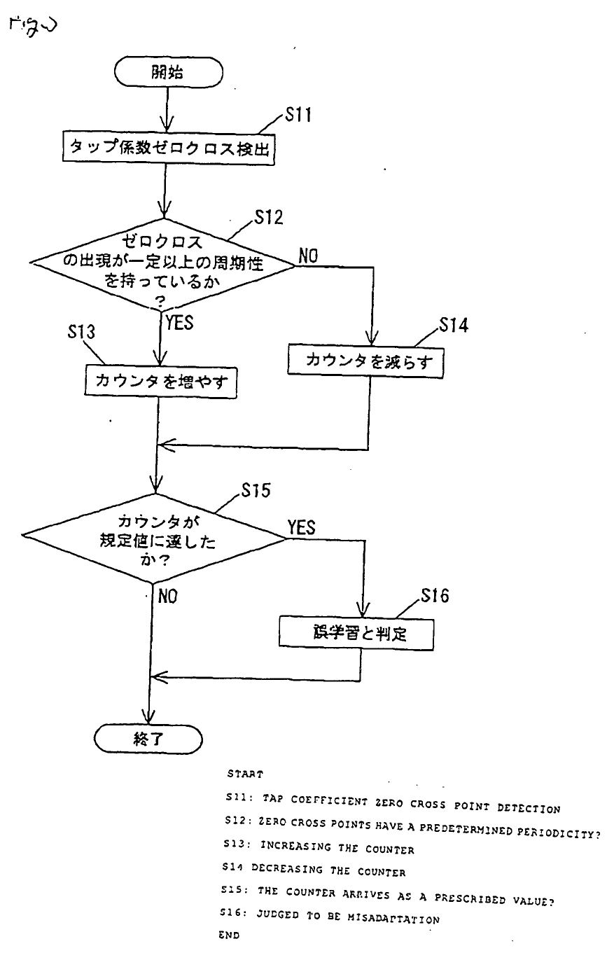

FIG. 5 is a flow chart showing the coefficient judging step S3 of FIG. 4.

In FIG. 5, starting the judging processing, the coefficient judging unit 205 sequentially detects the zero cross points of the tap coefficients within the filter 204 (S11). Continuously, the coefficient judging unit 205 checks whether the periodicity of the zero cross points is above a predetermined value (periodicity exists or not) (S12): when it is above, it judges that the periodicity exists and increases the value of the counter (S13), while otherwise, it judges that no periodicity exists and decreases the value of the counter (S14). The coefficient judging unit 205 checks whether the value of the counter arrives at a prescribed value or not (S15) when it arrives at the prescribed value, it judges that this is the misadaptation (S16), while otherwise, it finishes the judging step. Instead of providing the counter as mentioned above, a method of checking the misadaptation properly at each instance may be considered.

A preferred example, of the method in which the coefficient judging unit 205 checks the presence of the periodicity on the zero cross points of the tap coefficients in Step S12, will be described in detail by using FIG. 3(b).

The coefficient judging unit 205 sequentially detects the zero cross points of tap coefficients in the order of increasing the tap number. It measures the distance d₁ from the first detected zero cross point to the second detected zero cross point, the distance d₂ from the second detected zero cross point to the third detected zero cross point, and the distance dₙ from the n-th detected zero cross point to the (n+1)-th detected zero cross point. The coefficient judging unit 205 judges that the periodicity of the zero cross points exceeds the predetermined value (periodicity exists) when calculating the distribution of the measured distances d₁, d₂, . . . , dₙ , and it is smaller than some threshold. As the other periodicity judging method, a method disclosed in JP-A-11-205200 can be used.

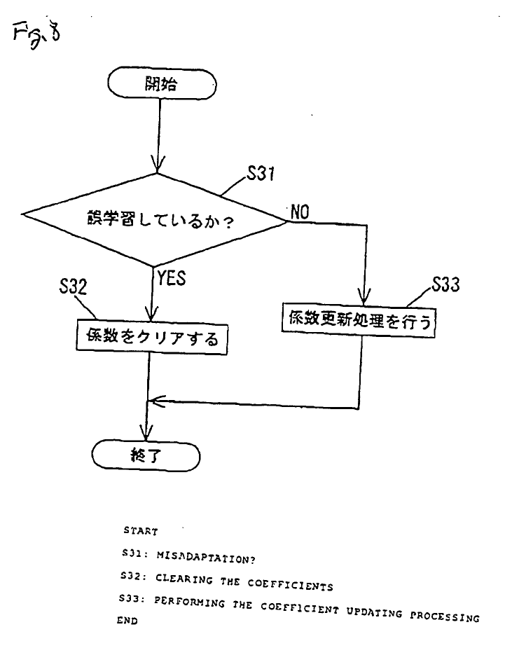

FIG. 8 is a flow chart showing the coefficient updating step S4 of FIG. 4.

In FIG. 8, starting the updating processing, the coefficient updating unit 203 confirms the state of learning of the tap coefficients (S31), based on the judgment result of the coefficient judging unit 205: when it is likely to misunderstand the tap coefficients, the unit 203 clears the tap coefficients (S32), while otherwise, it updates the tap coefficients (S33) based on the estimation result of the transfer function estimating unit 202, thereby finishing the update step. Although there is a preferred method of clearing the whole tap coefficients to zero in the coefficient clear step S32, it is possible to use various methods including a method of clearing only the tap judged to be affected, to zero, a method of reserving the coefficients as they are without clearing them at all, and the like.

As mentioned above, the embodiment is provided with the filter 204 for eliminating the echo component reflected back from the speaker 104 to the microphone 105, the transfer function estimating unit 202 for estimating a transfer function of the echo component, the coefficient judging unit 205 for judging the coefficient value of the filter 204, and the coefficient updating unit 203 for updating the coefficient value of the filter 204 based on the estimation result in the transfer function estimating unit 202 and the judgment result in the coefficient judging unit 205. Therefore, since the coefficient value of the filter 204 is updated based on the estimation result in the transfer function estimating unit 202 and the judgment result in the coefficient judging unit 205, it is possible to detect the misadaptation at an early state and correct it, hence to prevent from echo and howling, even when receiving a periodic signal and a fan noise.

Further, since the coefficient judging unit 205 sets the accurate judgment result by judging the presence of periodicity on the zero cross points of the coefficients, it is possible to detect the misadaptation at an early stage and correct it, hence to prevent from echo and howling more stably, even when receiving a periodic signal and a fan noise.

Further, it is possible to realize a stable telecommunication environment capable of preventing from influence of the acoustic echo component of the other phone terminal and suppressing echo and howling.

Further, when the computer readable recording medium with a program for executing each step of FIG. 4 and FIG. 5 recorded there, is used, the method of FIG. 4 and FIG. 5 can be performed at any position at any time by a computer's reading the recorded medium.

(Embodiment 2)

The structure of an echo canceler according to a second embodiment of the invention is the same as that of the first embodiment, as shown in FIG. 2. The operation of the echo canceler according to the second embodiment of the invention is the same as the operation as shown by the flow chart in FIG. 4 according to the first embodiment, excluding the method in which the coefficient judging unit judges the state of the tap coefficients.

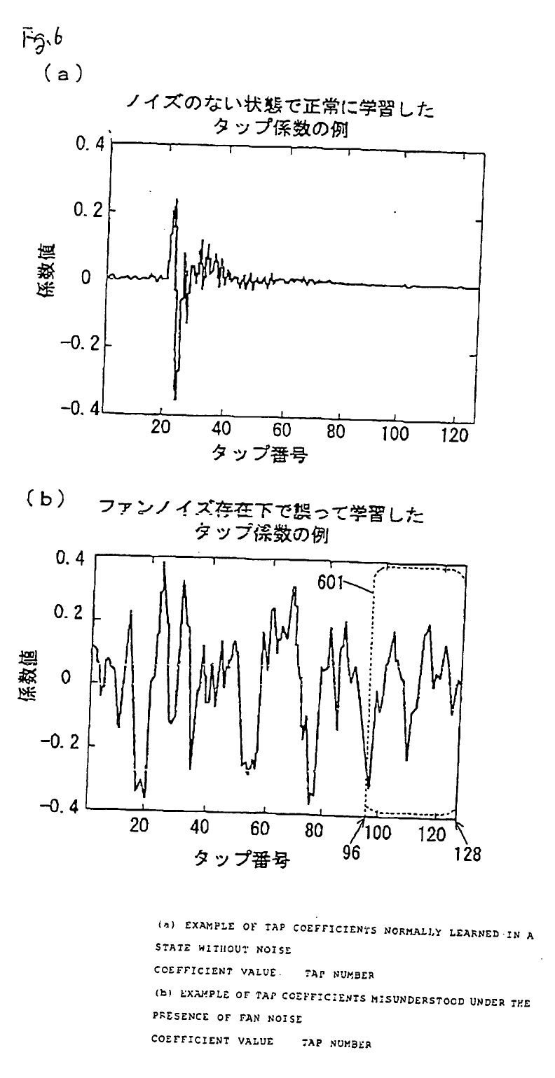

FIG. 6 shows a comparison about learning of the tap coefficients within the filter 204 depending on the presence of a fan noise: FIG. 6(a) is a graph showing an example of learning a transfer function normally (state without fan noise) and FIG. 6(b) is a graph showing an example of misadaptation it under the presence of fan noise (the other conditions are the same).

From FIG. 6, it is found that there is a difference of the tap coefficient values of the filter 204 between at the normal learning time and at the misadaptation time under the presence of fan noise. Especially, at the misadaptation time, latter half portion of the tap coefficients has a large power. Taking notice to this quality, the coefficient judging unit 205 judges a difference of the both, thereby making it possible to check whether the state of the tap coefficients of the filter 204 is preferable or not.

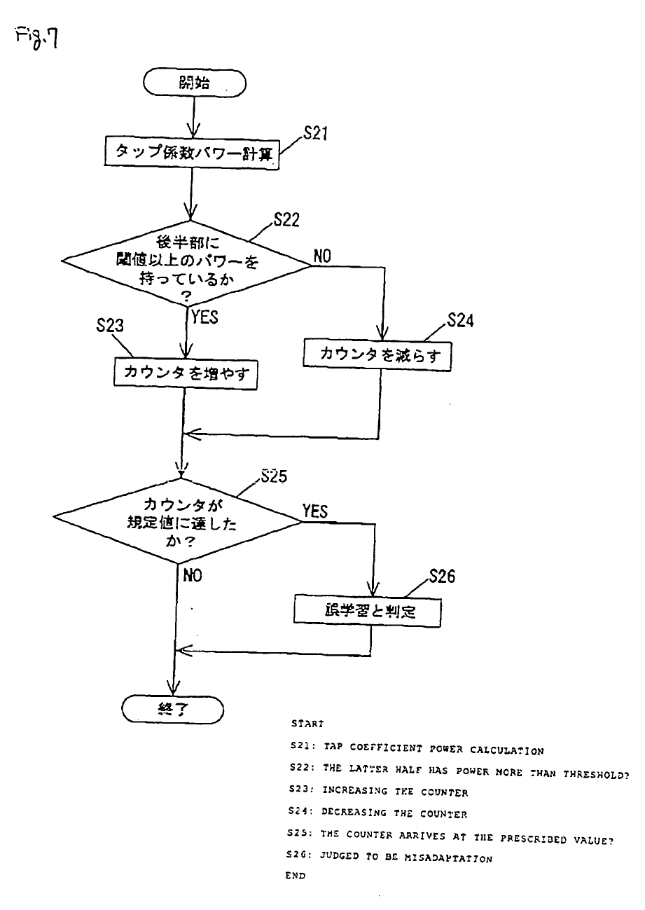

FIG. 7 is a flow chart showing the coefficient judging step S3 in FIG. 4.

In FIG. 7, starting the judging processing, the coefficient judging unit 205 calculates the power of every tap coefficient within the filter 204 (S21). The unit 5 judges whether the total power of the tap coefficients in the latter half exceeds a threshold or not (S22): when it exceeds the threshold, the unit 5 increases the value of the counter (S23), while otherwise, it decreases the value of the counter (S24). Further, it judges whether the value of the counter arrives at a prescribed value or not (S25): when it arrives at the prescribed value, it judges that this is the misadaptation (S26), while otherwise, it finishes the judging step. As for the judging step S22, various method are considered, including a method of comparing the total power of the tap coefficients in the head portion with the threshold, a method of comparing the ratio of the total power of the tap coefficients in the former half and their total power in the latter half with the threshold, and the like. Instead of providing with the counter as mentioned above, a method of checking, the misadaptation properly at each instance may be considered.

A preferred example, of the method in which the coefficient judging unit 205 checks the power of the tap coefficients in the latter half in Step S22, will be described in detail by using FIG. 6(b)

In order to judge the power of the tap coefficients in the latter half, as illustrated by the surrounded portion by a dotted line 601 in FIG. 6(b), the latter quarter of the tap coefficients, from the 96^{th} to th 128^{th} tap coefficients, are used, of all the tap coefficients up to the number 128. The 96^{th} tap coefficient is represented as x₉₆, the 97^{th} tap coefficient is represented as x₉₇, and similarly the 128th tap coefficient is represented as x₁₂₈. The coefficient judging unit 205 calculates X₉₆²+X₉₇²+. . . +X₁₂₈², and when the square total is larger than some threshold, it judges that the power total of the tap coefficients in the latter half exceeds the threshold.

FIG. 8 is a flow chart showing the coefficient updating step S4 of FIG. 4.

In FIG. 8, starting the update processing, the coefficient updating unit 203 confirms the state of learning of the tap coefficients (S31), based on the judgment result of the coefficient judging unit 205: in the case of misadaptation, it clears the tap coefficients (S32), while otherwise, it performs the updating processing of the tap coefficient (S33), based on the estimation result of the transfer function estimating unit 202, and finishes the updating step. As for the coefficient clear step S32, there is a preferable method of clearing the whole tap coefficients to zero, but various methods may be considered, including a method of clearing only the tap judged to be affected, to zero, a method of keeping the coefficients as they are without clearing, and the like.

As mentioned above, according to the embodiment, the coefficient judging unit 205 judges the presence of attenuation of the coefficient power, hence to make the judgment result accurate, and even when receiving a periodical signal and a fan noise, it is possible to detect the misadaptation at an early stage and correct it, thereby preventing from echo and howling more stably.

By using the computer-readable recording medium with a program for performing each step of FIG. 7 and FIG. 8 a recorded there, the method of FIG. 7 and FIG. 8 can be performed at any place at any time by a computer's reading the recording medium.

(Embodiment 3)

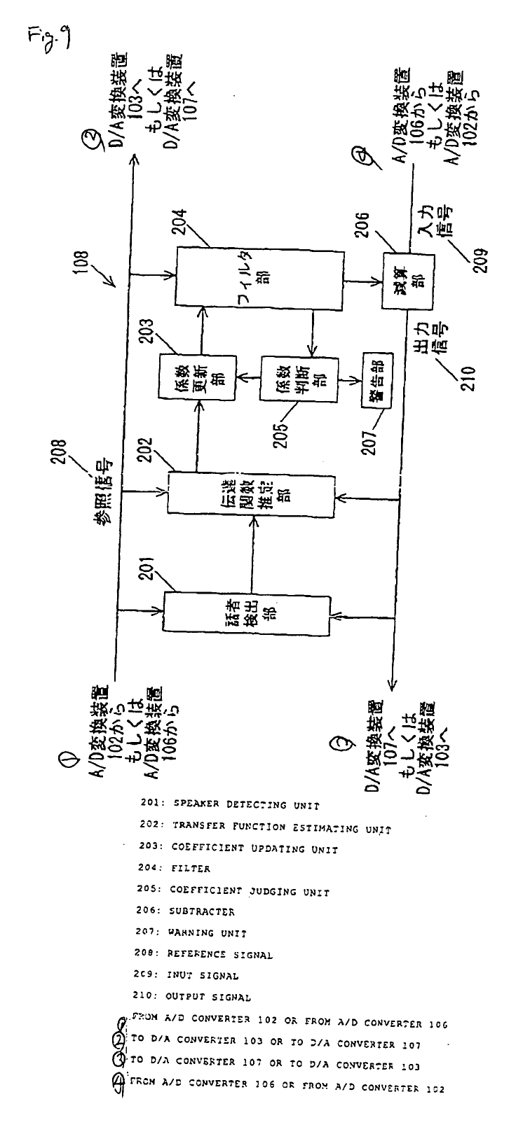

FIG. 9 is a function block view showing an echo canceler according to a third embodiment of the invention In FIG. 9, the speaker detecting unit 201, the transfer function estimating unit 202, the coefficient updating unit 203, the filter 204, the coefficient judging unit 205, and the subtracter 206 are the same as those of FIG. 2, with the same reference numerals attached, and the description thereof is omitted. The reference numeral 207 is a warning unit for aurally and visually warning when the judgment in the coefficient judging unit 205 results in the misadaptation.

The operation of the line echo canceler of FIG. 9 is the same as the operation shown in the flow chart of FIG. 4.

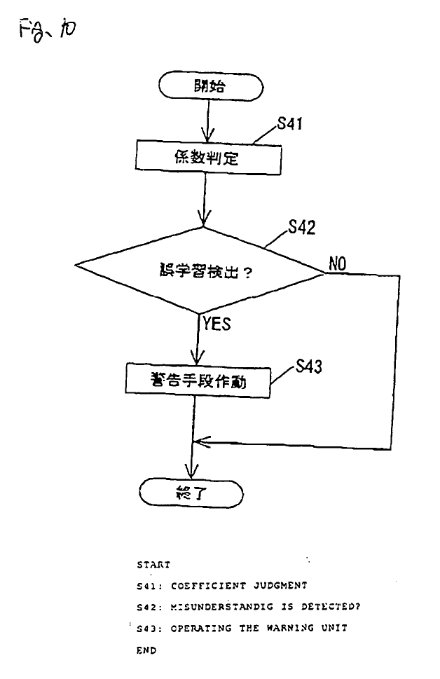

FIG. 10 is a flow chart showing the coefficient judging step S3 of FIG. 4.

In FIG. 10, when the coefficient judging unit 205 starts the operation, judges the state of the coefficients (S41), and detects the misadaptation (S42) it operates the warning unit 207 in the warning step (S43) while otherwise, it finishes the processing of the coefficient judging unit.

As mentioned above, since the embodiment is provided with the warning unit 207 for aurally and visually warning when the judgment in the coefficient judging unit 205 results in the misadaptation, the misadaptation can be notified to a user, which restrains the user from using the system under a circumstance where some signal disturbing the canceling processing of echo and howling occurs, hence to do a stabler canceling operation.

By using the computer readable recording medium with a program for performing each step recorded there, the method of FIG. 10 can be performed at any place at any time by a computer's reading the recording medium.

The echo canceler, the echo canceling method, and the recording medium according to the invention can be applied to a phone terminal used through a connection to a network such as a phone line, which is necessary to prevent from echo and howling.

### CROSS REFERENCE TO RELATED APPLICATION

This application is based upon and claims the benefit of priority of Japanese Patent Application No2003-170300 filed on 03/06/16 the contents of which are incorporated herein by reference in its entirety.

What is claimed is:

1. An echo canceller of a phone terminal having a line connector for connecting to a network, a speaker for supplying voice received from a far-end speaker, and a microphone for receiving voice of a close-end speaker, comprising:
a filter, which eliminates at least one of line echo component reflected back in the line connector and acoustic echo component reflected back from the speaker to the microphone;
a transfer function estimation unit, which estimates a transfer function of the echo component;
a coefficient judging unit, which judges a coefficient value of the filter; and
a coefficient updating unit, which updates the coefficient value of the filter, based on the estimation result in the transfer function estimating unit and the judgment result in the coefficient judging unit.

2. The echo canceller according to claim 1, wherein the coefficient judging unit judges presence of periodicity of zero cross points of coefficients.

3. The echo canceller according to claim 1, wherein the coefficient judging unit judges presence of attenuation of coefficient power.

4. The echo canceller according to claim 1, further comprising:
a warning unit, which aurally or visually warns when the judgment result in the coefficient judging unit is misadaptation.

5. The echo canceller according to claim 2, further comprising:
a warning unit, which aurally or visually warns when the judgment result in the coefficient judging unit is misadaptation.

6. The echo canceller according to claim 3, further comprising:
a warning unit, which aurally or visually warns when the judgment result in the coefficient judging unit is misadaptation.

7. An echo canceling method in a phone terminal having a line connector for connecting to a network, a speaker for supplying voice received from a far-end speaker, and a microphone for receiving voice of a close-end speaker, comprising the steps of:
eliminating at least one of line echo component reflected back in the line connector and acoustic echo component reflected back from the speaker to the microphone;
estimating a transfer function of the echo component;
judging coefficient values of the filter in the filter step; and
updating the coefficient values of the filter in the filter, based on the estimation result in the transfer function estimating step and the judgment result in the coefficient judging step.

8. The echo canceling method according to claim 7, wherein, in the step of judging, presence of periodicity of zero cross points of coefficients is judged.

9. The echo canceling method according to claim 7, wherein, in the step of judging, presence of attenuation of coefficient power is judged.

10. The echo canceling method according to claim 7, further comprising the steps of:
aurally or visually warning when the judgment result in the coefficient judging step is misadaptation.

11. The echo canceling method according to claim 8, further comprising the steps of:
aurally or visually warning when the judgment result in the coefficient judging step is misadaptation.

12. The echo canceling method according to claim 9, further comprising the steps of:
aurally or visually warning when the judgment result in the coefficient judging step is misadaptation.

13. A recording medium readable by a computer, in which a program for performing each step of the echo canceling method according to claim 7 is recorded.

14. A recording medium readable by a computer, in which a program for performing each step of the echo canceling method according to claim 8 is recorded.

15. A recording medium readable by a computer, in which a program for performing each step of the echo canceling method according to one of claims 9 is recorded.

16. A recording medium readable by a computer, in which a program for performing each step of the echo canceling method according to claim 10 is recorded.

17. A recording medium readable by a computer, in which a program for performing each step of the echo canceling method according to claim 11 is recorded.

18. A recording medium readable by a computer, in which a program for performing each step of the echo canceling method according to claim 12 is recorded.
